(19) United States
(12) Patent Application Publication
(10) Pub. No.: US 2009/0055805 A1
(43) Pub. Date: Feb. 26, 2009

(54) Method and System for Testing Software

(75) Inventor: Eli M. Dow, Poughkeepsie, NY (US)

Correspondence Address: SCULLY, SCOTT, MURPHY & PRESSER, P.C., 400 GARDEN CITY PLAZA, SUITE 300, GARDEN CITY, NY, 11530, US

(73) Assignee: International Business Machines Corporation, Armonk, NY (US)

(21) Appl. No.: 11/844,577

(22) Filed: Aug. 24, 2007

(51) Int. Cl. G06F 9/44

(52) U.S. Cl. 717/128

(57) ABSTRACT

A method and system are disclosed for testing the cpu scalability of a software application. The method comprises the steps of running the software application a plurality of times on a computer system such that each time the software application is ran on the computer system, a different number of processors are used to run the software application. The method further comprises the steps of storing the resultant outputs of the computer system, and using those outputs to determine the cpu scalability of the software application. In a preferred embodiment of the invention, a software tool, referred to as (he harness, is loaded onto the computer system to perform the running, storing and using steps. For instance, each time that the software application is run on (he computer system, the software tool may configure a different subset of the processors to run the software application.

### BACKGROUND OF THE INVENTION

1. Field of the Invention

This invention, generally, relates to software testing. More specifically, the invention relates to methods and systems for testing software to determine how the performance of a software application changes as the software application is run on different computer systems having different numbers of processing units.

2. Background Art

Modem computing systems often utilize large-scale and/or complex software systems. Typical examples of these software systems include operating systems, application servers, and other complex software applications. A key factor in developing and successfully marketing a complex software application is ensuring that the application works well with different computer systems having different numbers of processing units or cpus. The ability of the application to work with different numbers of cpus is referred to as the cpu scalability of the software.

Prior to this invention, cpu scalability testing on commodity hardware required a plethora of systems, each with a different psychical number of cpus. Software would be tested on a single machine with perhaps one processor. Later the same workload would be executed on another machine containing more processors.

A problem with previous solutions is that they are tedious to perform, require numerous physical servers consuming numerous resources. It is also a costly endeavor to manually examine the output of workloads to determine scalability coefficients.

### SUMMARY OF THE INVENTION

An object of this invention is to provide a method and system to determine the cpu scalability of a software system.

Another object of the present invention is to provide a single commodity machine sufficient for software cpu scalability testing.

A further object of the preferred embodiment of the invention is to provide a cpu affinity based autonomic performance regression system with optional integration of source code management systems.

These and other objectives are attained with a method and system for testing the cpu scalability of a software application. The method comprises the steps of running the software application a plurality of times on a computer system having a multitude of processors, including the steps of each of the plurality of times that the software application is run on the computer system, using a different number of said multitude of processors to run the software application, and generating a resultant output. The method further comprises the steps of storing the resultant outputs of die computer system, and using said resultant outputs to determine the cpu scalability of the software application.

In a preferred embodiment of the invention, a software tool, referred to as the harness, is loaded onto to the computer system to perform the running, storing and using steps. For instance, each of the plurality of times that the software application is run on the computer system, die software tool may be used to configure a different subset of said multitude of processors to run the software application.

With the present invention, the workload now includes additional information abut the processor configurations to be tested and is executed on a single n-way processor machine, where n is larger or equal to the maximum number of processors needed for execution. As a result, a single commodity machine is now sufficient for software cup scalability testing.

Further benefits and advantages of this invention will become apparent from a consideration of the following detailed description, given with reference to the accompanying drawings, which specify and show preferred embodiments of the invention.

### BRIEF DESCRIPTION OF THE DRAWINGS

FIG. 1 illustrates a software testing procedure embodying the present invention.

FIG. 2 shows a procedure, using a preferred embodiment of the invention, for determining how changes to a software application affect the performance of the application.

FIG. 3 shows a computer system mat may be used to implement this invention.

FIG. 4 is a block diagram of one of the processor of the computer system of FIG. 3.

### DETAILED DESCRIPTION OF THE PREFERRED EMBODIMENT

The present invention provides a method and system for testing software. More specifically, the invention provides a procedure for testing the cpu scalability of a software application—that is, determining how the performance of the software application changes as the application is run on computer systems having different numbers of cpus.

Generally, in this testing procedure, the software application is run a plurality of times on a computer system such that each time the software application is ran on the computer system, a different number of processors arc used to run the software application. The resultant outputs of the computer system are stored and used to determine the cpu scalability of the software application.

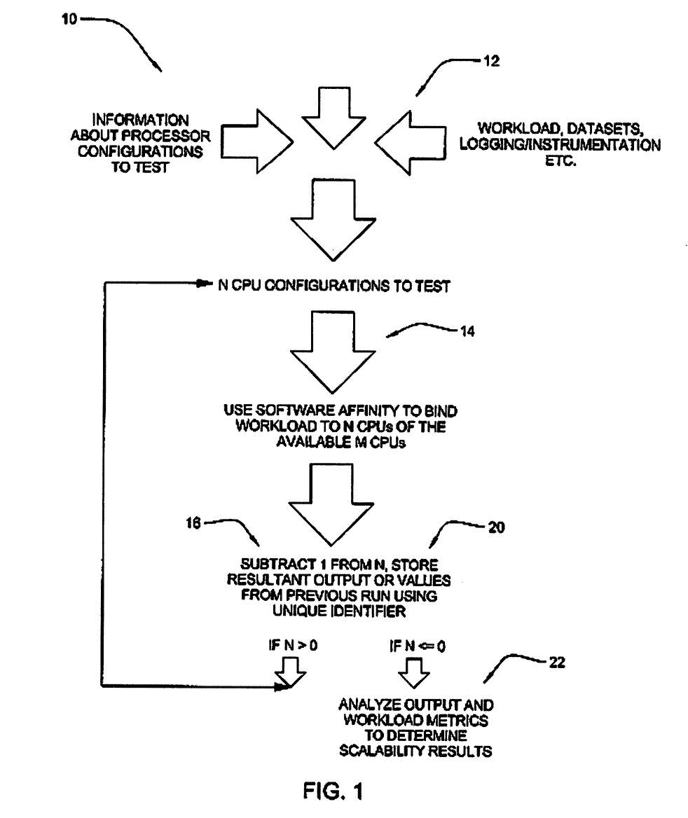

FIG. 1 shows a preferred method for implementing this procedure. Using a system for hard software affinity implemented in an operating system, one can construct a software program we will call the harness, which takes as input a workload for a given software scalability test. The workload may be any soft of software application along with additional information like datasets to be used etc. The workload harness wilt then execute the workload on a physical machine n times in succession, where n is less than or equal to the number of processors in a host machine executing the workload. With each increasing value for n, the harness will bind the workload to some subset of physical processors (where the size of that set is equal to n), using the hard software cpu affinity mechanism, perform a complete execution run, and store the resultant output, files, data, etc for the given workload execution. When all execution runs have completed, the results can be optionally processed by the test harness to determine a scalability coefficient. The determination of that scalability coefficient may be a chart, graph, numerical result based. The resultant output may or may not also apply an underlying knowledge of Amdahl's law.

The generalized Amdahl's law is:

$$\frac{1}{{\sum }_{k = 0}^{n} ( \frac{{P}_{k}}{{S}_{k}} )}$$

where

is a percentage of the instructions that can be improved (or slowed),

is the speed-up multiplier (where 1 is no speed-up and no slowing).

represents a label for each different percentage and speed-up, and

is the number of different speed-up/slow-downs resulting from the system change.

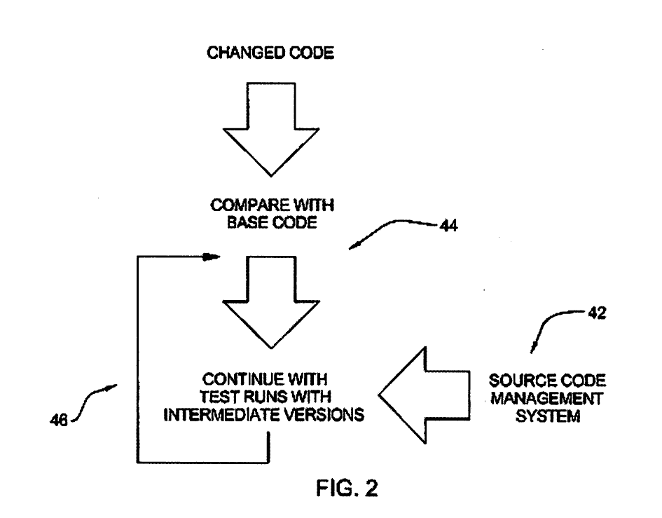

The present invention has a number of specific uses, and for example, as illustrated in FIG. 2, the invention may be used to test a software application that has been changed to determine how those changes affect the performance of the software application. This is done by using program 10 with a source code revision control system 42 to perform automatic regression runs based on a plurality of conditions (such as, for example, every commit, specified execution every time interval T, etc). The program 10, when invoked with source code management support, may run a completely new series of workload executions, as described above, determining the scalability metrics for a given snapshot from the source code management system. The harness program 10 may then, at 44, optionally compare the results to previous known execution results for the same code base, taken from an earlier snapshot. If a regression, (such as slowing down beyond some policy defined threshold) is detected in the software code, the harness program 10 may employ source code management features, such as a bisect command to continue regressions. These runs could continue, as represented at 46, until a particular offending commit is determined, at which point a policy can be invoked for handling the offending commit.

Any suitable multi-processor computer or computer system may be used in the practice of this invention. For example, the invention may be employed on a computing environment based on one or more zSeries 900 computers offered by the International Business Machines Corporation, Armonk, N.Y. High performance Computers (HPCs) may also be used in the implementation of the present invention.

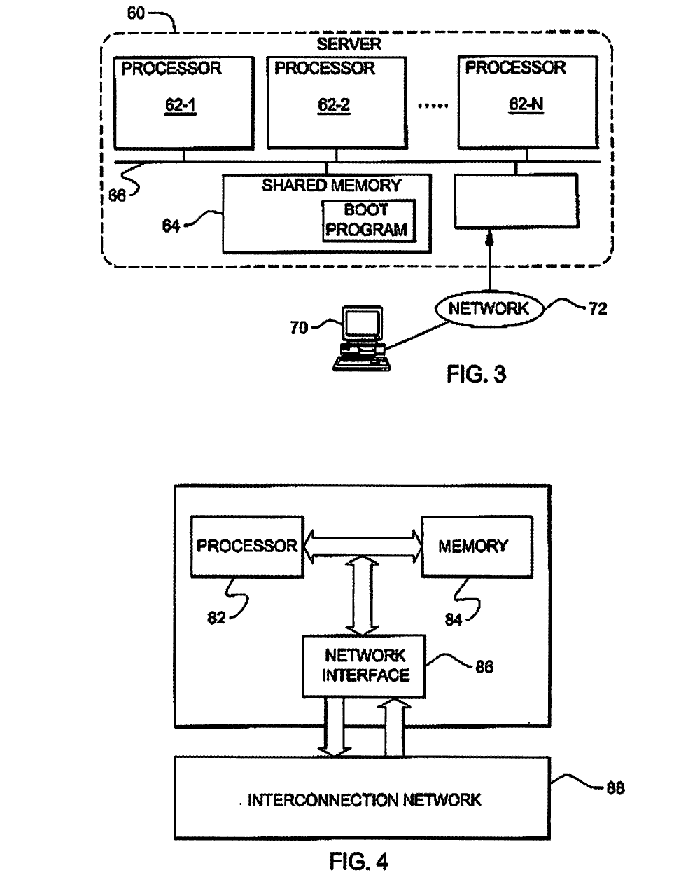

As an example, FIG. 3 shows one computing system that may be used. In particular. FIG. 3 shows a multi-processor server 60 including a multitude of processors 62-1 to 16-n. A shared memory 64 is connected to the processors via a bus 66, and the shared memory may include a boot program for activation control of the processors. FIG. 3 also shows a user or administration station 70 connected to server 60 via a network 72. As will be understood by those of ordinary skill in the ail, server 60 may include or be used with a plurality of additional items not shown in FIG. 3, and similarly, memory 16 may be provided with additional programs or data not illustrated in FIG. 3.

FIG. 4 is a block diagram showing in more detail one of the processors of system 10. As shown in FIG. 4, the processor element includes a processor unit 82, a memory unit 84 and a network interface 86. The processor unit and the memory unit are connected to each other and further connected to an interconnection network 88 via the network interface. As will be understood by those of ordinary skill in the art, any suitable processor may be used in the practice of this invention and the processor may include additional items or features not specifically shown in FIG. 4.

As will be readily apparent to those skilled in the art, the present invention can be realized in hardware, software, or a combination of hardware and software. Any kind of computer/server systems)—or other apparatus adapted for carrying out the methods described herein—is suited. A typical combination of hardware and software could be a general-purpose computer system with a computer program that, when loaded and executed, carries out the respective methods described herein. Alternatively, a specific use computer, containing specialized hardware for carrying out one or more of the functional tasks of the invention, could be utilized.

The present invention, or aspects of (he invention, can also be embodied in a computer program product, which comprises all the respective features enabling the implementation of the methods described herein, and which—when loaded in a computer system—is able to carry out these methods. Computer program, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

Also, the flow diagrams depicted herein are just examples. There may be many variations to these diagrams or the steps (or operations) described therein without departing from the spirit of the invention. For instance, steps may be performed in a differing order, or steps may be added, deleted, or modified. All of these variations arc considered a part of the claimed invention.

While it is apparent that the invention herein disclosed is well calculated to fulfill the objects stated above, it wilt be appreciated that numerous modifications and embodiments may be devised by those skilled in the art, and it is intended that the appended claims cover all such modifications and embodiments as fall within the true spirit and scope of die present invention.

What is claimed is:

1. A method of testing the cpu scalability of a software application, comprising the step of:
running the software application a plurality of times on a computer system having a multitude of processors, including the steps of:
each of the plurality of times that the software application is run on the computer system, using a different number of said multitude of processors to run the software application, and generating a resultant output;
storing the resultant outputs of the computer system; and
using said resultant outputs to determine the cpu scalability of the software application.

2. A method according to claim 1, comprising the further steps of:
loading a software tool onto the computer system; and
using said software tool to perform the running step.

3. A method according to claim 2, wherein the step of using said software tool includes the step of each of the plurality of times that the software application is run on the computer system, using the software tool to configure a different subset of said multitude of processors to rim the software application.

4. A method according to claim 2, wherein the step of using said software tool includes the step of using the software tool to perform the steps of storing the resultant outputs of the computer system, and using said resultant outputs to determine the cpu scalability of the software application.

5. A method according to claim 2, wherein the step of using said software tool includes the step of using the software tool (i) to run the software application successively said plurality of times, and (ii) each of the plurality of times the software application is run, to decrease the number of said multitude of processors used to run the software application.

6. A method according to claim 1, wherein the software application has a first version and a second version, and wherein:
the running step includes the steps of running the first version of the software application on the computer system to obtain a first set of result data, and running the second version of the software application on the computer system to obtain a second set of result data; and
the step of using said resultant outputs includes the step of comparing said first set of result data with said second set of result data to identify a regression in the second version of the software application.

7. A method according to claim 6, wherein the software application has a plurality of intermediate versions, and the running step includes the steps of:
using a source code management system to select one or more of said plurality of intermediate versions; and
running said selected one or more of the intermediate versions on the computer system to identify a condition causing said regression.

8. A method according to claim 1, wherein the step of running the software application includes the step of running a defined workload including said software application and an associated set of additional information a plurality of times on the computer system.

9. A method according to claim 8, wherein the step of using a different number of said multitude of processors includes the step of, each of die plurality of times that the workload is run, binding the workload to a different subset of said multitude of processors.

10. A method according to claim 1, wherein the step of using said resultant outputs includes the step of comparing said resultant outputs to determine a scalability coefficient for the software application.

11. A software testing system for testing the cpu scalability of a software application, the software testing system comprising a computer system having a set of processors and computer readable code for:
running the software application a plurality of times, and for each of said plurality of tunes, generating a resultant output, wherein each of said times that the software application is run on the computer system, a different number of said processors are used to run the software application;
storing the resultant outputs of the computer system; and
using said resultant outputs to determine the cpu scalability of the software application.

12. A software testing system according to claim 11, wherein said computer system includes a software tool for performing said storing and using.

13. A software testing system according to claim 12, wherein said software tool includes computer readable code to configure a different subset of said multitude of processor to run the software application each of the plurality of times that the software application is run on the computer system.

14. A software testing system according to claim 12, wherein the software tool includes computer readable code to run the software application successively said plurality of times, and each of the plurality of times the software application is run, to decrease the number of said multitude of processors used to run die software application by a predetermined number.

15. A software testing system according to claim 12, wherein the software application has a first version, a second version, and one or more intermediate versions, and for use with a source code management system, and wherein:
the computer system includes computer readable code for running the first version of the software application on the computer system to obtain a first set of result data, for running the second version of the software application on the computer system to obtain a second set of result data, and comparing said first set of result data with said second set of result data to identify a regression in the second version of the software application;
the source code management system is adapted to select one or more of said plurality of intermediate versions; and
the computer system includes computer readable code for running said selected one or more of the intermediate versions on the computer system to identify a condition causing said regression.

16. An article of manufacture comprising:
at least one computer usable medium having computer readable program code logic to test the cpu scalability of a software application ran on a computer system, wherein said computer system has a multitude of processors, and generates resultant output when the software application is run on the computer system, the computer readable program code logic comprising:
running logic for running the software application a plurality of times on the computer system, and each time the software application is run on the computer system, for using a different number of said multitude of processors to run the software application;
storing logic for storing the resultant outputs of the computer system; and
determination logic for using said resultant outputs to determine the cpu scalability of the software application.

17. An article of manufacture, according to claim 16, wherein each of the plurality of times that die software application is run on the computer system, a different subset of said multitude of processors is configured to ran the software application.

18. An article of manufacture according to claim 16, wherein the determination logic uses said resultant outputs to determine a scalability coefficient for the software application.

19. An article of manufacture according to claim 16, wherein the running logic (i) runs the software application successively said plurality of times; and (ii) each of the plurality of times the software application is run, decreases the number of said multitude of processors used to run the software application.

20. An article of manufacture according to claim 16, wherein the software application has a first version and a second version, and wherein:
the running logic runs the first version of the software application on the computer system to obtain a first set of result data, and runs the second version of the software application on the computer system to obtain a second set of result data; and
the determination logic compares said first set of result data with said second set of result data to identify a regression in the second version of the software application.
